(19) United States
(12) Patent Application Publication
(10) Pub. No.: US 2026/0171860 A1
(43) Pub. Date: Jun. 18, 2026

(54) THERMAL MANAGEMENT FOR ROTOR COOLING IN ELECTRIC MACHINE

(71) Applicant: FCA US LLC, Auburn Hills, MI (US)

(72) Inventors: Prashant Modi, Auburn Hills, MI (US); Dhafar Al-Ani, Auburn Hills, MI (US)

(21) Appl. No.: 18/981,998

(22) Filed: Dec. 16, 2024

(51) Int. Cl. H02K 1/32; H02K 9/19

(52) U.S. Cl. CPC H02K 1/32; H02K 9/19

(57) ABSTRACT

An electric machine having a thermal management system and for use in an electrified vehicle includes a rotor, a stator, a housing, and a thermal management system. The electric machine can also include an oil feed channel at least partly positioned in the housing and configured to provide cooling oil to at least the rotor. The rotor can include a rotor shaft having a longitudinal axis of rotation; a rotor core positioned about the rotor shaft, where the rotor core includes a first axial end and a second, opposed axial end; and a helical oil channel formed and positioned in the rotor core, and forming a helical or spiral oil flow path between the first and second axial ends of the rotor for receiving cooling oil flow from the oil feed channel to cool at least the rotor.

### FIELD

The present application generally relates to thermal management of electric machines and, more particularly, to thermal management of a rotor of an electric machine, such as for use in electrified vehicle powertrains.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A conventional electric machine includes a stator and a rotor. The stator is supplied with energy (i.e., current) to generate a magnetic field that causes the rotor to rotate and generate torque. The operation of an electric machine generates heat which causes the temperature of the components inside the electric machine to rise, such as the magnets in the rotor for Permanent Magnet (PM) types of electric machines, the bars in the rotor for induction machines (IMs), and the coils in the externally excited synchronous machine (EESM). Such magnets have thermal limits, above which they begin to lose their effectiveness (demanganization). As a result, conventional electric machines often limit their performance to maintain rotor temperatures below such thermal limits. One example implementation of such an electric machine is in a vehicle's torque generating system or transmission for propulsion. These conventional electric machines are typically directly cooled by employing oil spray/splash in direct contact with the electric machine's outer axial ends. While such electric machine thermal management techniques do work for their intended purpose, there remains a desire for improvement in the relevant art.

### SUMMARY

According to one example aspect of the invention, an electric machine having a thermal management system is provided for use in an electrified vehicle. In one exemplary implementation, the electric machine also includes a rotor, a stator, and a housing. The electric machine can also include an oil feed channel at least partly positioned in the housing and configured to provide cooling oil to at least the rotor. The rotor can include a rotor shaft having a longitudinal axis of rotation; a rotor core positioned about the rotor shaft, the rotor core including a first axial end and a second, opposed axial end; and a helical oil channel formed and positioned in the rotor core, and forming a helical or spiral oil flow path between the first and second axial ends of the rotor for receiving cooling oil flow from the oil feed channel to cool at least the rotor.

In some implementations, the helical oil flow path includes a plurality of spirals circumferentially positioned around the longitudinal axis and axially offset from each other.

In some implementations, a length of the helical oil channel measured in terms of a distance the cooling oil travels through the helical oil channel is greater than an axial length of the rotor core.

In some implementations, the helical oil channel includes two helical oil channels.

In some implementations, the helical oil channel includes an arcuate shape in cross-section form the viewpoint of a radial cross-sectional of the rotor.

In some implementations, the rotor core includes one or more magnets positioned at a radial distance from the rotor shaft, and wherein the helical oil channel is positioned in the rotor core in an area between the rotor shaft and the one or more magnets.

In some implementations, the rotor core includes a plurality of lamination plates stacked together in a direction of the longitudinal axis from the first axial end to the second axial end in a stacked configuration to form the rotor, and wherein each of the plurality of staked lamination plates includes an arc-shaped channel such that the helical oil channel is formed in the stacked configuration of the plurality of lamination plates. In some implementations, the stacked configuration of the plurality of lamination plates includes a first laminate plate proximate the first axial end and remaining stacked lamination plates, and wherein the arc-shaped channel in each remaining stacked lamination plate is rotationally offset from a prior lamination plate while partially overlapping the arc-shaped channel in the prior lamination plate thereby forming the helical oil channel.

In some implementations, the cooling oil for the helical oil channel flows into the rotor core from an end plate of the rotor.

In some implementations, the cooling oil for the helical oil channel flows into the rotor core from the shaft of the rotor.

In some implementations the helical or spiral oil flow path of the helical oil channel is a continuous path.

In some implementations, the rotor shaft includes a hollow shaft configured to receive the cooling oil and direct the same to contact end windings of the electric machine to cool the end windings.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

The present disclosure will become more fully understood from the detailed description and the accompanying drawings, given purely by way of non-limiting example, wherein:

FIG. 1 is an example radial cross-sectional schematic view of an electric machine according to the prior art;

FIG. 2 is an example axial cross-sectional schematic view of the electric machine according to the prior art;

FIG. 3 is an example axial cross-sectional schematic view of an improved electric machine having an improved thermal management system including one or more helical or spiral rotor channels for receiving cooling oil to cool at least the rotor according to the principles of the present application;

FIG. 4A is an example radial cross-sectional schematic view of a rotor lamination plate of the improved electric machine having an exemplary arc-shaped oil channel according to the principles of the present application;

FIG. 4B is an example schematic illustration of the arc-shaped oil channels of the plurality of the lamination plates of FIG. 4A stacked in a manner to form the rotor as well as a single spiral or helical oil path in the rotor according to the principles of the present application;

FIG. 5A is an example radial cross-sectional schematic view of a rotor lamination plate of the improved electric machine having two exemplary arc-shaped oil channels according to the principles of the present application;

FIG. 5B is an example schematic illustration of the two arc-shaped oil channels of the plurality of the lamination plates of FIG. 5A stacked in a manner to form the rotor as well as two spiral or helical oil paths in the rotor according to the principles of the present application;

FIG. 6 is an example axial cross-sectional schematic view of the improved electric machine illustrating in part the oil cooling circuit for at least the rotor and the end windings according to the principles of the present application; and

FIGS. 7A-7D illustrates various example channel shapes that may be formed in the rotor laminations to form the cross-sectional shape of the helical oil channel in accordance with the principles of the present application.

### DETAILED DESCRIPTION

As previously discussed, the operation of an electric machine generates heat which causes the temperature of the components inside the electric machine to rise. At least two of the important components in the electric machine that need to be cooled are the rotor and the stator. Certain magnets in the rotor are typically demagnetized at temperatures above ˜150 degrees Celsius (based on the type and grade of magnet) and electric machine operation is often constrained to ensure that the magnet temperature does not exceed this threshold.

A conventional electric machine thermal management technique is oil cooling by spraying/splashing. Oil cooling architectures use oil spray/splash directly on the machine surfaces for cooling, such as typically the axial ends of the rotor and stator. The heat is dissipated from contact of the cooling oil and the heat sources. This method is typically referred to as “direct-oil-spray-cooling”. One main approach is oil spray from the center towards the stator, driven by rotor rotation. In this approach, the oil is sprayed from the shaft ends towards the end-windings and stator laminations. In this case oil spray is driven by centrifugal forces caused by the rotation of the rotor. This approach attempts to cool the rotor by heat transfer via external rotor surfaces. The external rotor surfaces are mainly the rotor axial ends, exposed to the cooling oil.

Most of the direct-oil-spray-cooling methods described previously cool the rotor by heat transfer from the external end surfaces. For rotors made by stacking steel laminations, the axial thermal conductivity of the rotor is typically an order lower than the radial and circumferential thermal conductivities. This results in elevated temperatures in the core of the rotor. As a result, improved electric motor (rotor) thermal management structures and techniques are presented. These techniques involve cooling the rotor (and in particular the rotor core) by routing oil flow through one or more internal channels of the rotor, such as helical or spiral channels or paths, to directly cool the rotor.

The improved thermal management system of the application can be applied to various types of electric machines or machines including, but not limited to, Interior Permanent Magnet (IPM), Surface-mounted Permanent Magnet (SPM), Induction Machine (IM), Switching reluctance Machine (SRM) Permanent Magnet-Assisted Synchronous Reluctance Machine (PMSRM), Wound Rotor Synchronous Machine (WRSM), Axial Flux Machine, and Externally Excited Synchronous Machine (EESM).

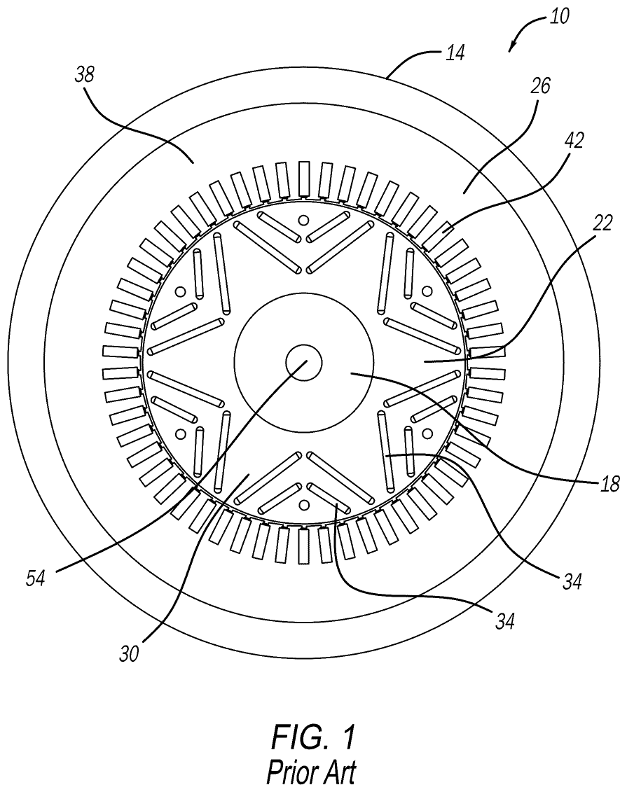

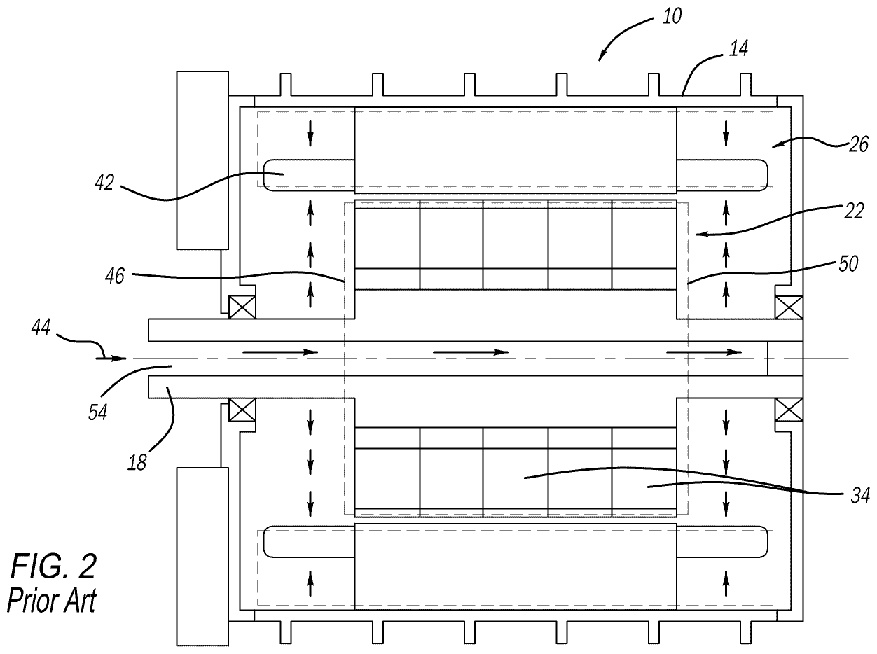

Turning now to the drawings, FIGS. 1 and 2 show certain main components of a conventional electric machine identified at reference numeral 10. The electric machine 10 includes a housing 14, a central hollow shaft 18 supporting a rotor 22, and a stator 26. In one example implementation, the rotor 22 includes and is formed by a plurality of rotor lamination plates 30 and magnets 34, as is known in the art. In this example implementation, the stator 26 includes stator laminations 38 and windings 42, as is also known in the art. In this example, the rotor 22 and stator 26 are cooled using the direct-oil-spray technique discussed above where oil 44 is splashed on the respective axial ends 46, 50 of the rotor 22 and stator 26.

The electric machine 10 can be utilized in an electrified powertrain of a vehicle. The electrified powertrain, in one example is controlled by one or more controllers or a control system so as to achieve a desired/requested amount of drive torque in response to a driver pedal request. The powertrain may include one or more electric machines 10 that generate drive torque and are selectively coupled to or form part of a transmission for transfer of drive torque to a driveline.

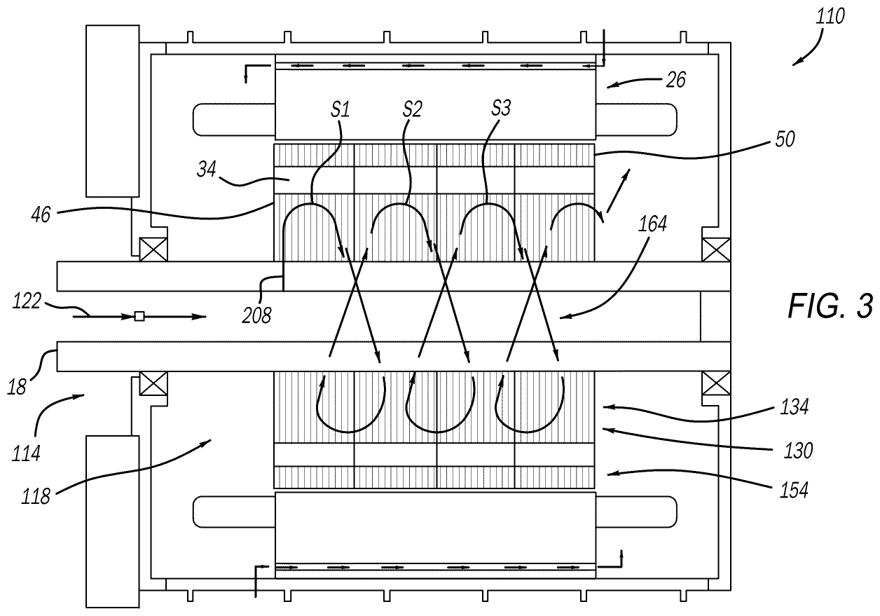

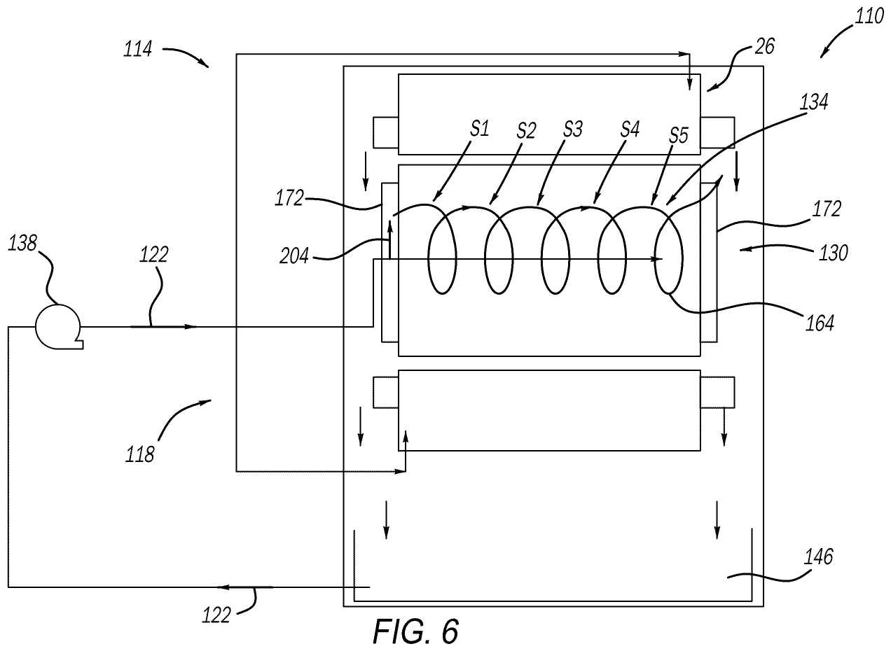

Turning now to FIGS. 3 and 6, and with continuing reference to FIGS. 1-2, an improved electric machine 110 having an improved thermal management system 114 will now be discussed in accordance with the principles of the present application. Components of electric machine 110 that are substantially similar or the same as in electric machine 10 will retain the same reference numerals.

Electric machine 110 includes the thermal management system 114, which includes an improved cooling oil circuit 118. The cooling circuit 118 facilitates cooling fluid, such as cooling oil 122, flowing and/or circulating through a housing or housing assembly 126 of electric machine 110 and through an improved rotor 130. The improved rotor 130 includes a cooling channel system 134 configured to receive the cooling oil 122 to cool the rotor 130. The cooling oil 122 can be circulated through the cooling circuit 118 by a pump 138 drawing the oil 122 from an oil sump 146.

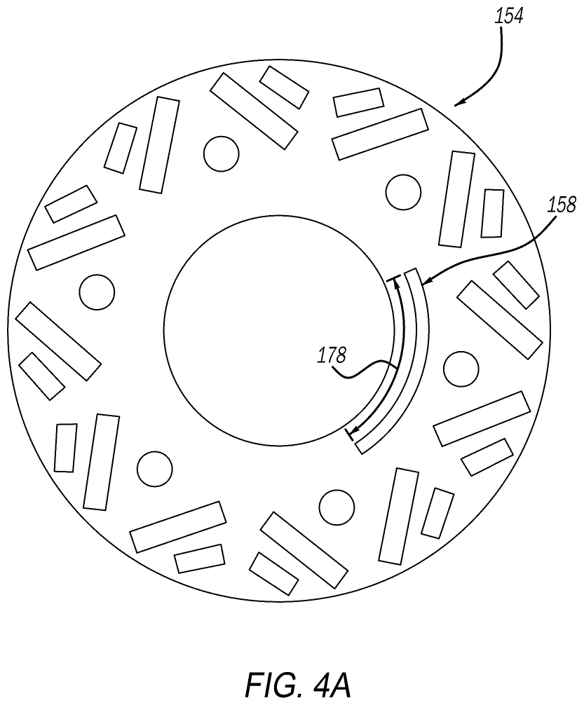

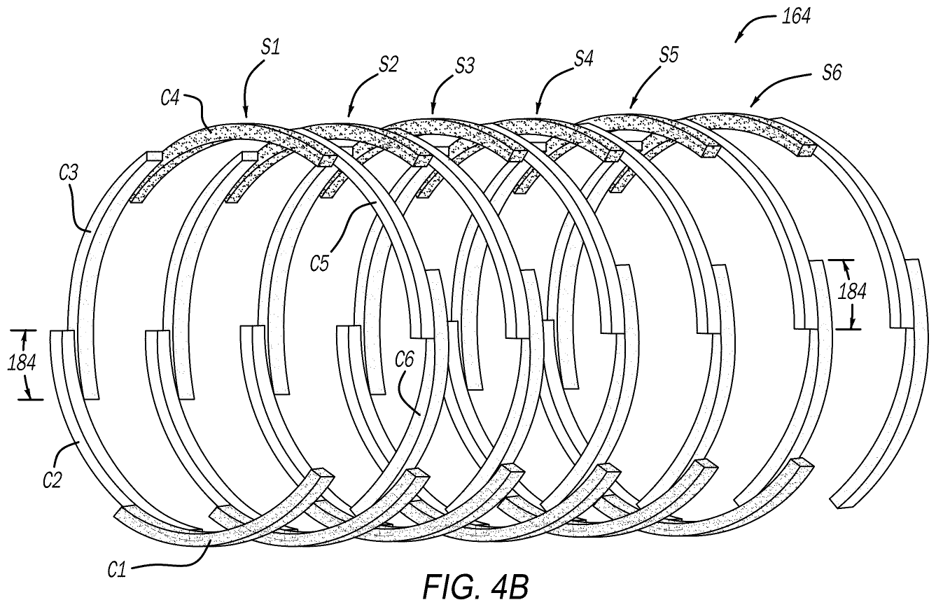

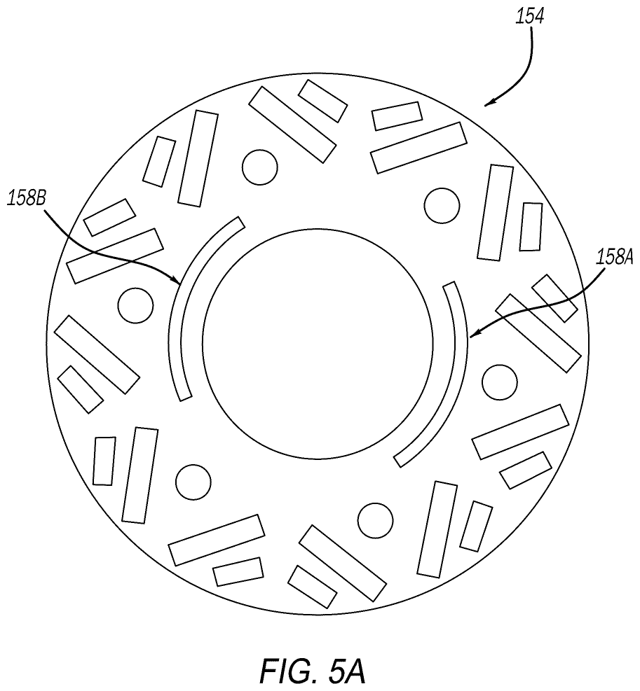

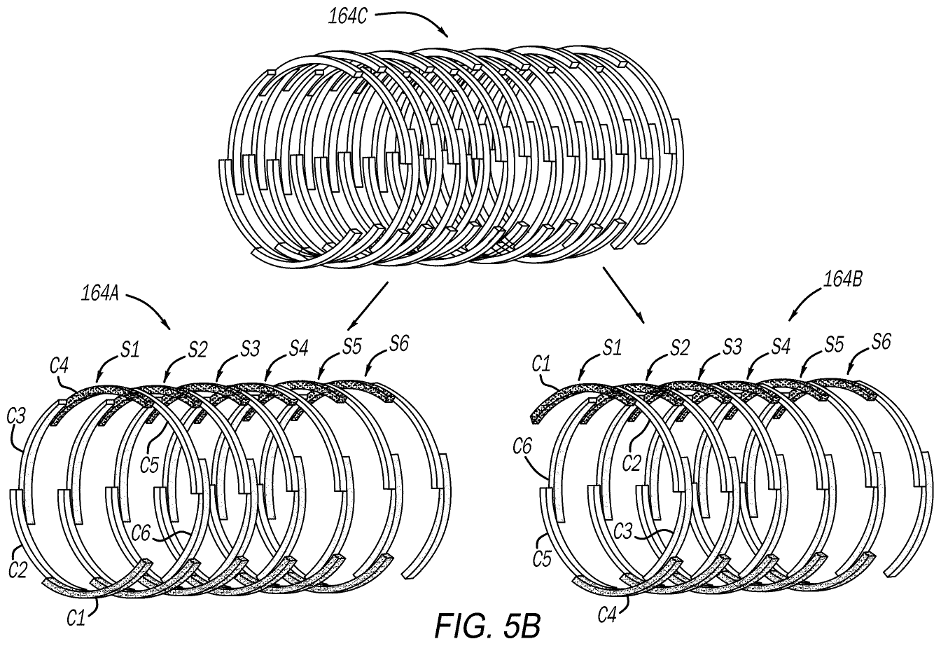

Before continuing with a discussion of the improved thermal management system 114, it will be appreciated that the rotor 130 can be formed using various techniques, including through the use of a plurality of stacked rotor lamination plates 154, as is generally known in the art of rotor manufacturing. In this regard, the radial schematic views of FIGS. 4A and 5A can be viewed as a radial sectional view of the rotor or a single lamination plate 154 with various cutouts and/or pockets for the magnets as well as one or more arc-shaped channels 158, as discussed herein. In this example construction, the axial sectional schematic view of FIG. 3 illustrates a complete stack of a plurality of lamination plates 154 stacked/coupled together along the longitudinal axis of the rotor 130 to form the rotor or rotor core 130 with the arc-shaped channels 158 forming one or more helical oil channels or paths 164, as discussed herein.

Turning now to FIGS. 4A-4B, an example of the improved thermal management system 114 having the one or more helical oil channels 164 will now be discussed. In this example, the rotor or rotor core 130 includes at least one helical oil channel 164 extending from or substantially from the first axial end 46 of the rotor 130 to the second axial end 50 thereof. As will be discussed in greater detail below, the cooling oil 122 can enter the rotor core 130 directly from the hollow rotor shaft 18 or from a rotor end plate 172. As briefly mentioned above, in the example of the rotor 130 being formed by stacking the plurality of lamination plates 154, one arc-shaped channel 158 in each individual rotor lamination plate 154 forms the one helical oil channel 164 when the plates 154 are stacked together.

Before continuing with the discussion, for the sake of clarity, FIG. 4B represents an illustration of an example helical oil channel 164 formed in rotor 130 where only the arc-shaped channels 158 are illustrated and they are shown in a positive form instead of the negative or cut-out form shown in FIG. 4A. As will be appreciated, this is for clarity of illustration and for discussion purposes of an example of the invention. The arc-shaped channels 158 shown in positive form also include various different shading solely for clarity of illustration and visual differentiation of the plurality of channels illustrated.

In the example shown in FIG. 4B, each lamination plate 154 following the first lamination plate 154, which is positioned at or substantially at the first axial end 46, or forming the first axial end 46, is rotated about its rotational axis relative to the prior lamination plate 154 so that the arc-shaped channel 158 is angularly/rotationally offset but still overlapping with the arc-shaped channel 158 of the prior lamination plate 154. This angularly rotated and offset positioning is continued with each successive lamination plate 154 in the stacked lamination plate configuration to form the helical oil channel 164 through the lamination plates 154 from the first axial end 46 to the second axial end 50, or from the first to the last lamination plate 154, in the stacked lamination plate arrangement.

More specifically, and with continued reference to FIG. 4B, this illustration represents an example where thirty-six (may vary as explained below) lamination plates 154 are utilized to form the rotor core 130. The angular offsetting and overlapping of each arc-shaped channel 158 of the thirty-six lamination plates 154 results in six spiral paths (S1-S6) traveling substantially round the rotor shaft 18, where six arc-shaped channels 158 (C1-C6), and thus five lamination plates 154, form each spiral (S1-S6). It will be appreciated that the length 178 of each arc-shaped channel 158 in each lamination plate 154, and the amount of overlap 184 of two mating arc-shaped channels 158 of two adjacent or mating lamination plates 154, can determine how many arc-shaped channels 158 are needed to form a spiral substantially around the rotor shaft 18. It will also be appreciated that the first and/or the last spiral S1, S6, may include less than six arc-shaped channels 158 and thus the formed helical oil channel 164 in this example may use less than thirty-six lamination plates 154.

As will also be appreciated, using longer or shorter length 178 arc-shaped channels 158 can vary a width in radial cross-section of the formed helical oil channel 164. Using longer or shorter length 178 arc-shaped channels 158 can also vary an overall length of the helical oil channel 164 so as to be, for example, significantly longer than the axial length of the rotor 130. This length of the helical oil channel 164 is measured by the distance oil flows through the entire channel 164 such that with a greater number of spirals and/or with less axial spacing between the spirals, the length of the helical oil channel 164 can increase significantly.

With additional reference to FIGS. 5A and 5B and continuing reference to FIGS. 3-4B, another example helical oil channel configuration 164C will now be discussed. In this example, two helical oil channels 164A and 164B are formed in the rotor core 130. Each helical oil channel 164A, 164B is formed in the same or similar manner as discussed in connection FIGS. 4A and 4B and the single channel 164 shown therein. In this example, two arc-shaped channels 158A, 158B are positioned in each lamination plate 154 and are spaced circumferentially apart from each other, as shown in FIG. 5A. These two arc-shaped channels 158A and 158B will result in the two helical oil channels 164A, 164B when in the stacked lamination plate rotor core configuration 130.

It will be appreciated that while FIG. 5A illustrates the arc-shaped channels 158A, 158B being of the same size and shape, such channels can be different from each other in terms of length and radial thickness and cross-sectional shape. It will also be appreciated that while the subject channels are shown diametrically opposed to each other, they can also be positioned at different circumferential orientations relative to each other. The helical oil channels 164 discussed herein can serve two critical purposes—rotor 130 weight reduction to increase efficiency, and cooling of the rotor 130 via oil 122 flowing through the one or more helical oil channels 164, as will be discussed in greater detail below.

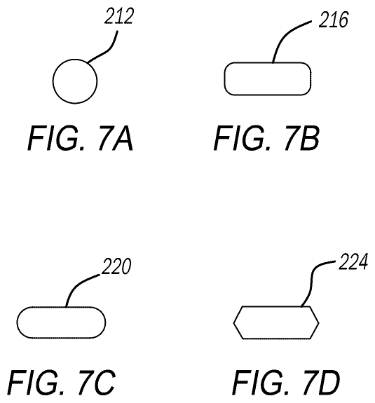

With reference now to FIGS. 7A-7D and continuing reference to FIGS. 3-6B, various alternative shapes (in cross-section) for the helical oil channels 164 are illustrated. The shapes shown in FIGS. 7A-7D represent the shape cut out or stamped into the rotor lamination plates 154. The shapes include, but are not limited to, a circular shape 212, a rectangular shape 216, a slot with rounded ends 220, and a slot with converging ends 224.

In operation, such as operation of the electrified vehicle using the electric machine 110, cooling oil 122 is circulated through the cooling oil circuit 118 including the rotor cooling system 134, via pump 138 and the cooling oil sump 146. In one example implementation generally shown in FIG. 6, pump 136 circulates cooling oil 122 from sump 146 into passage 204 of rotor end plate 172 for flow into the helical oil channel(s) 164. In another example implementation generally shown in FIG. 3, pump 136 circulates cooling oil 122 from sump 146 into passage 208 of rotor shaft 18 directly into rotor 130 and helical oil channel(s) 164. The cooling oil 122 then flows through the helical oil channel(s) 164 and can then spray over and between the end windings 42 and or the axial ends 46. 50 to cool the same.

The cooling oil 122 flowing through the helical oil channel(s) 164 provides direct, improved cooling of the rotor 130 as well as improved indirect cooling of the stator via heat transfer. This rotor 130 cooling has been shown to be significantly more effective than merely cooling the axial ends of the rotor. As a result of this improved cooling, the power and efficiency of the electric machine can be increased thereby using more potential of the rotor magnets without breaching the thermal limits of such magnets.

The improved rotor design discussed herein with the helical oil channels provides improved rotor thermal management by taking advantage of the increased residence time of the cooling oil in the rotor core due to the overall length of the helical oil channel in the rotor being significantly greater than the axial length of the rotor. This increased residence time together with the increased surface cooling area (due to the longer path) not only improves cooling performance but also improves temperature uniformity without adding any additional space or mass to the rotor or electric machine.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Some portions of the above description may present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electric machine having a thermal management system and for use in an electrified vehicle, the electric machine including a rotor, a stator and a housing, the electric machine comprising:
an oil feed channel at least partly positioned in the housing and configured to provide cooling oil to at least the rotor;
the rotor including:
a rotor shaft having a longitudinal axis of rotation;
a rotor core positioned about the rotor shaft, the rotor core includes a first axial end and a second, opposed axial end;
a helical oil channel formed and positioned in the rotor core, and forming a helical or spiral oil flow path between the first and second axial ends of the rotor for receiving cooling oil flow from the oil feed channel to cool at least the rotor.

2. The electric machine of claim 1, wherein the helical oil flow path comprises a plurality of spirals circumferentially positioned around the longitudinal axis and axially offset from each other.

3. The electric machine of claim 1, wherein a length of the helical oil channel, measured in terms of a distance the cooling oil travels through the helical oil channel, is greater than an axial length of the rotor core.

4. The electric machine of claim 1, wherein the helical oil channel comprises two helical oil channels.

5. The electric machine of claim 1, wherein the helical oil channel includes an arcuate shape in cross-section from the viewpoint of a radial cross-section of the rotor.

6. The electric machine of claim 1, wherein the rotor core comprises one or more magnets positioned at a radial distance from the rotor shaft, and wherein the helical oil channel is positioned in the rotor core in an area between the rotor shaft and the one or more magnets.

7. The electric machine of claim 1, wherein the rotor core comprises a plurality of lamination plates stacked in a stacked configuration together in a direction of the longitudinal axis from the first axial end to the second axial end to form the rotor, and wherein each of the plurality of staked lamination plates includes an arc-shaped channel such that the helical oil channel is formed in and by the stacked configuration of the plurality of lamination plates.

8. The electric machine of claim 7, wherein the stacked configuration of the plurality of lamination plates comprises a first laminate plate proximate the first axial end and remaining stacked lamination plates, and wherein the arc-shaped channel in each remaining stacked lamination plate is rotationally offset from a prior lamination plate while partially overlapping the arc-shaped channel in the prior lamination plate thereby forming the helical oil channel.

9. The electric machine of claim 1, wherein the cooling oil for the helical oil channel flows into the rotor core from an end plate of the rotor.

10. The electric machine of claim 1, wherein the cooling oil for the helical oil channel flows into the rotor core from the shaft of the rotor.

11. The electric machine of claim 1, wherein the helical or spiral oil flow path of the helical oil channel is a continuous path.

12. The electric machine of claim 1, wherein the rotor shaft comprises a hollow shaft configured to receive the cooling oil and direct the same to contact end windings of the electric machine to cool the end windings.
